(19) United States
(12) Patent Application Publication
(10) Pub. No.: US 2026/0204056 A1
(43) Pub. Date: Jul. 16, 2026

(54) PARALLEL SEQUENCE MODELING VIA GENERALIZED SPATIAL PROPAGATION NETWORK

(71) Applicant: NVIDIA Corporation, Santa Clara, CA (US)

(72) Inventors: Sifei Liu, San Diego, CA (US); Hongjun Wang, Sai Ying Pun (HK); Wonmin Byeon, Santa Cruz, CA (US); Jinwei Gu, Sunnyvale, CA (US); Charles Cheung, Eastern (HK); Xiaolong Wang, San Diego, CA (US); Jan Kautz, Lexington, MA (US)

(21) Appl. No.: 19/387,335

(22) Filed: Nov. 12, 2025

Related U.S. Application Data
(60) Provisional application No. 63/746,133, filed on Jan. 16, 2025.

(51) Int. Cl. G06V 10/82; G06T 11/00; G06V 10/764

(52) U.S. Cl. CPC G06V 10/82; G06T 11/00; G06V 10/764

(57) ABSTRACT

In machine learning, attention mechanisms are used to determine the importance of each component in a sequence relative to the other components in that sequence. Attention mechanisms enable artificial intelligence models to focus on the most relevant parts of data to provide context-aware outputs, which improves tasks such as machine translation, text summarization, image captioning, speech recognition, etc. Traditional attention models compute attention for multi-dimensional data for every possible pair of data elements in the multi-dimensional data or sequentially element-by-element, both approaches of which are computationally expensive and time-consuming. The present disclosure provides an attention mechanism that employs multi-dimensional linear propagation when computing attention information, which can improve spatial coherence and efficiency by directly operating on spatially coherent image data and forming dense pairwise connections through the multi-dimensional linear approach.

### CLAIM OF PRIORITY

This application claims the benefit of U.S. Provisional Application No. 63/746,133 titled “PARALLEL SEQUENCE MODELING VIA GENERALIZATION SPATIAL PROPAGATION NETWORK,” filed Jan. 16, 2025, the entire contents of which is incorporated herein by reference.

### TECHNICAL FIELD

The present disclosure relates to attention models for machine learning.

### BACKGROUND

In machine learning, attention mechanisms are used to determine the importance of each component in a sequence relative to the other components in that sequence. Attention mechanisms enable artificial intelligence models to focus on the most relevant parts of data to provide context-aware outputs, which improves tasks such as machine translation, text summarization, image captioning, speech recognition, etc. Existing attention mechanisms include self-attention for in-depth context modeling and cross-attention for multi-source integration, which together can capture intricate dependencies across data elements.

Traditional attention models compute attention for multi-dimensional data on an all-to-all basis, meaning attention is computed for every possible pair of data elements in the multi-dimensional data. While this classic technique provides comprehensive attention information, it requires significant compute and memory resources. As a solution, many more recent attention models, including transformers, linear attention, and state-space models, process the multi-dimensional data as one-dimensional (1D) sequences, propagating attention information element-by-element from the first element to the last element in the sequence. However, this element-to-element propagation compromises spatial coherence and still limits efficiency.

There is thus a need for addressing these issues and/or other issues associated with the prior art. For example, there is a need for an attention mechanism that employs multi-dimensional linear propagation when computing attention information, which can improve spatial coherence and efficiency by directly operating on spatially coherent image data and forming dense pairwise connections through the multi-dimensional linear approach.

### SUMMARY

A method, computer readable medium, and system are disclosed to provide attention information for multi-dimensional data. Attention information is computed for at least a portion of a multi-dimensional datum using multi-dimensional linear propagation. The attention information is provided to a downstream task to be performed for the at least a portion of a multi-dimensional datum.

### BRIEF DESCRIPTION OF THE DRAWINGS

FIG. 1 illustrates a flowchart of a multi-dimensional linear propagation method to provide attention information for multi-dimensional data, in accordance with an embodiment.

FIG. 2 illustrates a conceptualization of the multi-dimensional linear propagation method of FIG. 1 compared with the all-to-all and element-by-element computation methods of the prior art, in accordance with an embodiment.

FIG. 3 illustrates a conceptualized flow of the multi-dimensional linear propagation method of FIG. 1 as applied to multi-dimensional data, in accordance with an embodiment.

FIG. 4 illustrates a system architecture of a generalized spatial propagation network (GSPN) module, in accordance with an embodiment.

FIG. 5 illustrates a system architecture of a GSP block for discriminative tasks, in accordance with an embodiment.

FIG. 6 illustrates a system architecture of a GSP block for a generative task, in accordance with an embodiment.

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 illustrates an example data center system, according to at least one embodiment.

### DETAILED DESCRIPTION

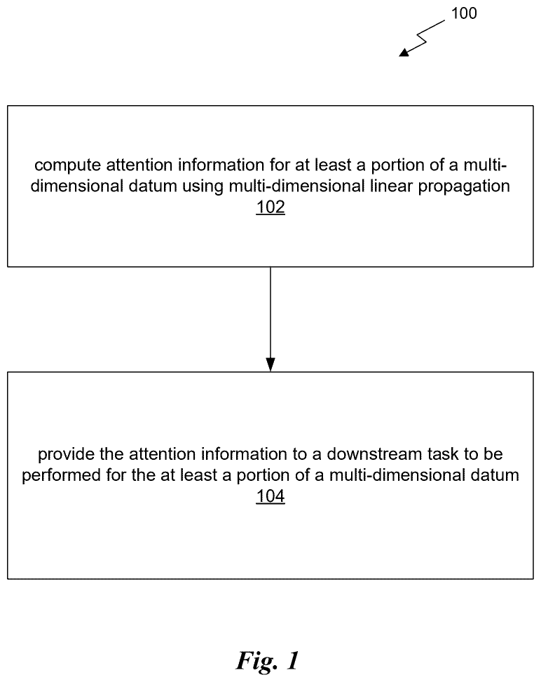

FIG. 1 illustrates a flowchart of a multi-dimensional linear propagation method 100 to provide attention information for multi-dimensional data, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, attention information is computed for at least a portion of a multi-dimensional datum using multi-dimensional-dimensional linear propagation. With respect to the present description, the multi-dimensional datum refers to a collection of elements that are defined in multiple dimensions. In an embodiment, the multi-dimensional datum may be a 2D datum. The multi-dimensional datum may higher-dimensional datum, such as three-dimensional (3D) datum, in some embodiments.

In an embodiment, the multi-dimensional datum may be an image. In an embodiment, the multi-dimensional datum includes a sequence of elements. In an embodiment, the sequence of elements may be defined in rows and columns. In an embodiment where the multi-dimensional datum is an image, the sequence of elements may include a sequence of pixels.

As mentioned, attention information is computed for at least a portion of the multi-dimensional datum using multi-dimensional linear propagation. With respect to the present description, the multi-dimensional linear propagation is configured in accordance with the multi-dimensional datum (e.g. 2D linear propagation is used for 2D data). With respect to the present description, the attention information refers to an importance of an element of the multi-dimensional datum relative to the other elements of the multi-dimensional datum. In an embodiment, the attention information may be computed for an entirety of the multi-dimensional datum using the multi-dimensional linear propagation. In an embodiment, the attention information may be computed for only a portion (e.g. 2D region, etc.) of the multi-dimensional datum using the multi-dimensional linear propagation.

In an embodiment, computing the attention information may include capturing a local context for each of a plurality of regions of the multi-dimensional datum. In an embodiment, computing the attention information may include capturing a global context across an entirety of the multi-dimensional datum. In an embodiment, computing the attention information may include capturing both the local context and the global context. In an embodiment, the attention information may be computed without use of positional embeddings.

In any case, the attention information is computed using multi-dimensional linear propagation, which in an embodiment refers to line-by-line propagation through at least a portion of the multi-dimensional datum. In an embodiment, the multi-dimensional linear propagation may be performed per row of the multi-dimensional datum or per column of the multi-dimensional datum. In an embodiment, the multi-dimensional linear propagation may be performed per feature channel of a plurality of feature channels.

In an embodiment, the multi-dimensional linear propagation may be a linear recurrent process that includes, for each (e.g. 2D) line in the at least a portion of a multi-dimensional datum, computing each item in a hidden state by: computing a weighted sum of neighboring values from hidden states of a prior (e.g. 2D) line to form a first result, computing an element-wise product of the line with a scaling parameter to form a second result, and computing a sum of the first result and the second result. In an embodiment, the neighboring values may be values of three elements in the prior line that are directly adjacent to the item in the hidden state.

In an embodiment, weights used to compute the weighted sum may be stored in a normalized tridiagonal matrix. In an embodiment, the weights may be learnable and input-dependent. In an embodiment, the normalized tridiagonal matrix is row stochastic. In an embodiment, the scaling parameter is learnable and input-dependent.

In operation 104, the attention information is provided to a downstream task to be performed for the at least a portion of a multi-dimensional datum. In an embodiment, the attention information may be output via a single output layer of a neural network used to compute the attention information. In an embodiment, the attention information may be output from the neural network to another neural network that is configured to perform the downstream task using the attention information. In an embodiment, the attention information may be computed via a network module that is incorporated into a foundation model configured for the downstream task.

In an embodiment, the downstream task may be a computer vision task. For example, the computer vision task may be image classification. As another example, the computer vision task may be class-conditional image generation. As yet another example, the computer vision task may be text-to-image generation.

To this end, the multi-dimensional linear propagation method 100 provides attention information for multi-dimensional data. The multi-dimensional linear propagation approach allows multi-dimensional (e.g. line-by-line) propagation across a multi-dimensional datum. Accordingly, in an embodiment, for a 2D datum comprised of a sequence of N elements, 2D linear propagation can reduce the effective sequence length to VN.

### Exemplary Implementation of the Method 100

In an embodiment, attention information for at least a portion of a multi-dimensional datum is computed using multi-dimensional linear propagation, per the operation 102. In addition, a computer vision task is performed using the attention information to generate an output for the at least a portion of a multi-dimensional datum. For example, the attention information may be provided to a downstream task to be performed for the multi-dimensional datum, per operation 104, and in the present exemplary implementation of the method 100 the downstream (computer vision) task is then performed using the attention information to generate an output for the at least a portion of a multi-dimensional datum. In an embodiment, the multi-dimensional datum is an image, the computer vision task is image classification and the output corresponds to a predicted class label for the image.

Further embodiments will now be provided in the description of the subsequent figures. It should be noted that the embodiments disclosed herein with reference to the method 100 of FIG. 1 may apply to and/or be used in combination with any of the embodiments of the remaining figures below.

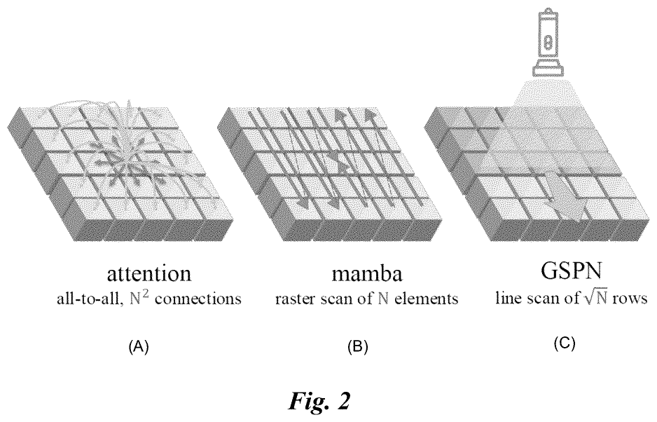

FIG. 2 illustrates a conceptualization of the multi-dimensional linear propagation method 100 of FIG. 1 compared with the all-to-all and element-by-element computation methods of the prior art, in accordance with an embodiment.

As shown, a traditional attention model (A) computes attention for a multi-dimensional datum on an all-to-all basis, namely for every possible pair of datum elements in the multi-dimensional datum. While this classic technique provides comprehensive attention information, it requires significant compute and memory resources. More recent attention models, including transformers, linear attention, and state-space models such as Mamba (B), process the multi-dimensional datum as one-dimensional (1D) sequences, propagating attention information element-by-element from the first element to the last element in the sequence. This element-to-element propagation compromises spatial coherence and limits efficiency.

Embodiments of the present description, also referred to herein as Generalized Spatial Propagation Network (GSPN) (C) employ 2D linear propagation when computing attention information. This 2D linear propagation approach can reduce the effective sequence length to \sqrt{N}, thereby improving efficiency while also improving spatial coherence.

### GSPN Overview

As disclosed herein, the GSPN is a linear attention mechanism optimized for multi-dimensional data such as images. In an embodiment, GSPN includes a Stability-Context Condition, which ensures both stability and effective long-range context propagation across multi-dimensional sequences by maintaining a consistent propagation weight norm. This condition allows information from distant elements to influence large spatial areas meaningfully while preventing exponential growth in dependencies, thus enabling stable and context-aware propagation essential for vision tasks. In an embodiment, with a linear line-scan operation, GSPN parallelizes propagation across rows and columns, reducing the effective sequence length to VN, significantly enhancing the computational efficiency, as illustrated in FIG. 2. This makes GSPN a robust and scalable framework that overcomes the key limitations of existing attention mechanisms by inherently capturing multi-dimensional spatial structures.

In an embodiment, during propagation, GSPN computes a weighted sum for each pixel using pixels from its previous row or column, with weights that are learnable and input-dependent. In an embodiment, GSPN can use a 3-way connection for parameter efficiency, optionally with a 4-direction integration that ensures full pixel connectivity, thereby forming dense pairwise connections through the line-scan manner. Two variants of GSPN are disclosed herein: one that captures global context across the entire input and another that focuses on local regions for faster propagation. These variants allow GSPN to seamlessly integrate into modern vision architectures as a drop-in replacement for existing attention modules. In an embodiment, a learnable merger is provided that aggregates spatial information from all scanning directions, which enhances the model's ability to adapt dynamically to the multi-dimensional structure of visual data. In an embodiment, by inherently incorporating positional information through scanning, GSPN eliminates the need for positional embeddings and avoids common aliasing issues.

As a new sub-quadratic attention block tailored for vision, GSPN provides both effectiveness and efficiency for a diverse range of visual tasks, including deterministic tasks like ImageNet classification, and generative tasks such as class-conditional generation (DiT) and text-to-image (T2I) generation.

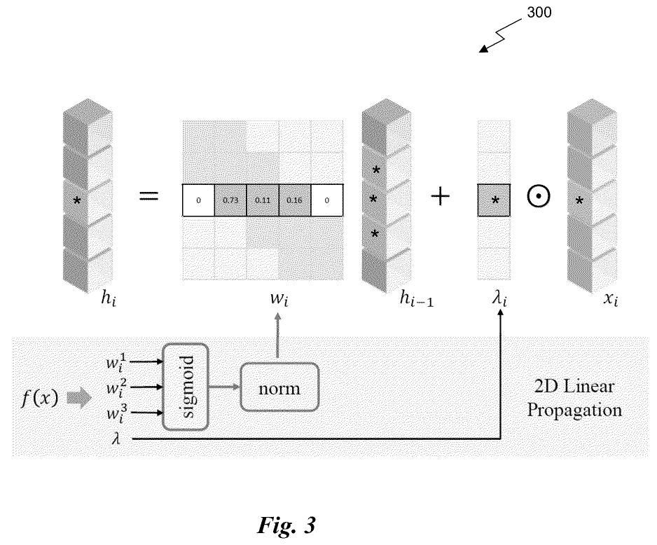

FIG. 3 illustrates a conceptualized flow 300 of the multi-dimensional linear propagation method 100 of FIG. 1 as applied to multi-dimensional data, in accordance with an embodiment. This flow 300 illustrates a possible implementation of the multi-dimensional linear propagation method 100 of FIG. 1.

### 2D Linear Propagation

Linear propagation in 2D proceeds through sequential row-by-row or column-by-column processing. The following embodiments are disclosed with respect to a 2D image x∈ [symbol] ^{n×n×C}. It should be noted that while a square image is assumed for simplicity, the embodiments described herein generalize to any multi-dimensional input of arbitrary dimensions. It should also be noted that while the following embodiments use row-by-row propagation as the illustrative case, embodiments for any other line-by-line processing may likewise we used.

The 2D propagation follows a linear recurrent process, defined in Equation 1.

$${h}_{i}^{c} = {w}_{i}^{c} {h}_{i - 1}^{c} + {λ}_{i}^{c} ⊙ {x}_{i}^{c} , i ∈ [ 1 , n - 1 ] , c ∈ [ 0 , C - 1 ] \qquad Equation 1$$

where h∈ [symbol] ^{n×n×C} is the hidden layer. Here, xᵢ and hᵢ denote the i-th row of the input x and hidden state h. For each channel c, the propagation uses two learnable parameters.

$${w}_{i}^{c} ∈ {ℝ}^{n \times n} ,$$

, an n×n matrix that weights

$${h}_{i - 1}^{c} ,$$

and

$${λ}_{i}^{c} {ℝ}^{n} ,$$

which scales

$${x}_{i}^{c}$$

element-wise using ○. Omitting the channel index c for simplicity, an output layer is applied element-wise via uᵢ∈ [symbol] ⁿ, per Equation 2.

$${y}_{i} = {u}_{i} ⊙ {h}_{i} \qquad Equation 2$$

### Expanded Form

The vectorized sequence of concatenated rows of hidden states and inputs is as

$$H = {〈 {h}_{1}^{T} , {h}_{2}^{T} , … , {h}_{n}^{T} 〉}^{T} T and X = {〈 {x}_{1}^{T} , {x}_{2}^{T} , … , {x}_{n}^{T} 〉}^{T}$$

Extending Equation 1 gives H=GX, where G is a lower triangular N×N matrix with n×n sub-matrices relating hᵢ and xⱼ, defined per Equation 3.

$${G}_{i j} = \{ \begin{matrix}{\prod }_{τ = j + 1}^{i} {w}_{τ} {λ}_{j} , & j ∈ [ 0 , i - 1 ] \\ {λ}_{j} , & i = j\end{matrix} \qquad Equation 3$$

Leveraging Equation 2, the output yᵢ can be represented as a weighted sum of X, per Equation 4.

$${y}_{i} = {u}_{i} {\sum }_{j = 0}^{t} {\prod }_{τ = j + 1}^{i} {w}_{τ} {λ}_{j} {x}_{j} \qquad Equation 4$$

Here, the notation is slightly abused by using λⱼ and uᵢ to denote n×n diagonal matrices with their original vector values on the main diagonal.

### Relation to Linear Attention

By substituting xⱼ with values Vⱼ and parameterizing uᵢ and λᵢ with feed-forward network layers, i.e., uᵢ=f_{Q}(xᵢ) and λᵢ=f_{K}(xᵢ), analogous to query and key representations, yᵢ can be rewritten per Equation 5.

$${y}_{i} = {f}_{Q} ( {x}_{i} ) {\sum }_{j = 0}^{t} {\prod }_{τ = j + 1}^{i} {w}_{τ} {f}_{K} ( {x}_{j} ) {V}_{j} \qquad Equation 5$$

Intuitively, Equation 5 represents a non-normalized linear attention mechanism with causal masking, where the additional propagation matrix

$${\prod }_{τ = j + 1}^{i} {w}_{τ}$$

modulates the strength of attention.

### Stability-Context Condition

As described herein,

$${\prod }_{τ = j + 1}^{i} {w}_{τ}$$

can be designed to achieve stability and effective long-range propagation. Letting

$${W}_{i j} = {\prod }_{τ = j + 1}^{i} {w}_{τ} .$$

dense interactions between hᵢ and

$${x}_{j}^{′} = {λ}_{j} {x}_{j}$$

can be ensured, even when i and j are far apart, if (i) Wᵢⱼ is a dense matrix, and (ii)

$${\sum }_{j = 0}^{n - 1} {W}_{i j} = 1 ,$$

so that each element in hᵢ is a weighted average of all elements in x′ⱼ. The following introduces Theorems 1 and 2, collectively referred to as the Stability-Context Condition, which meet these requirements.

Theorem 1. If all the matrices w_{τ} are row stochastic, then

$${\sum }_{j = 0}^{n - 1} {W}_{i j} = 1$$

is satisfied.

Definition. A matrix T is row stochastic if (i) all elements are non-negative, Tᵢⱼ≥0 for all (i, j); and (ii) the sum of elements in each row is 1, ΣⱼTᵢⱼ=1 for all i.

Proof. The theorem holds because the product of row stochastic matrices is also row stochastic.

Theorem 2. The stability of Equation 1 is ensured when all matrices w_{τ} are row stochastic.

Proof. Making w_{τ} row stochastic is a sufficient condition to ensure stability.

### Propagation Layer

In an embodiment, the Stability-Context Condition may be satisfied by learning a full matrix w_{τ} that outputs n weights per pixel, i.e., connecting all pixels in the previous row to each pixel in the current row, and normalizing the weights so that they sum to 1. However, this approach significantly increases the number of feature dimensions. To address this, another embodiment may include connecting each pixel to three pixels from the previous row: the top-left, top-middle, and top-right pixels in the top-to-bottom propagation direction. As a result, w_{τ} becomes a tridiagonal matrix. Importantly, multiplying multiple tridiagonal matrices results in a dense Wᵢⱼ, satisfying the requirements of the Stability-Context Condition outlined above. In addition, the line scan from 4 directions may be used, i.e., left-to-right, top-to-bottom, and vice-versa, to ensure dense pairwise connections among all pixels.

For each propagation direction, to ensure the matrix w_{τ} to be row stochastic, let w_{τ,i,j} be an element in row i and column j. Suppose each row i has mi non-zero entries. As illustrated in FIG. 3,

$${w}_{i}^{k}$$

is the pre-sigmoid value of the kth non-zero element in row i. The sigmoid function is applied to each non-zero element

$$σ ( {w}_{i}^{k} ) = 1 / ( 1 + {e}^{- {w}_{i}^{k}} )$$

and then the entries in row i are normalized so that they sum to 1. Thus, each non-zero element in row i can be expressed per Equation 6.

$${w}_{τ , i , j} = \frac{σ ( {w}_{i}^{k} )}{{\sum }_{{k}^{′} = 1}^{{m}_{i}} ( {w}_{i}^{k} )} \qquad Equation 6$$

where k indexes the mi non-zero entries in the i-row.

The above embodiments are illustrated in FIG. 3 as follows. For the i-th row, each item in the hidden state hᵢ is computed by: (1) a weighted sum of three neighboring values from the hidden layer hᵢ₋₁, where weights form a normalized tridiagonal matrix wᵢ, and (2) the element-wise product of the current input xᵢ with λ. wᵢ and λ are both learnable and input-dependent parameters. The weights in wᵢ are obtained by applying sigmoid activation followed by row-wise normalization.

### Efficient CUDA Implementation

In an embodiment, the linear propagation layer in Equation 1 can be implemented via a customized CUDA kernel. The kernel function employs a parallelized structure with an adjustable p threads per block (e.g. p=512 threads per block) and

$$q = \frac{B C {n}^{2} k ( p + 1 )}{p}$$

blocks per grid, where B represents the mini-batch size and k denotes the number of propagation directions. Each thread processes a single pixel in the input image along the propagation direction, enabling full parallelization across the batch, channels, and rows/columns orthogonal to the propagation. This design effectively reduces the kernel loop length to n, facilitating efficient and scalable linear propagation.

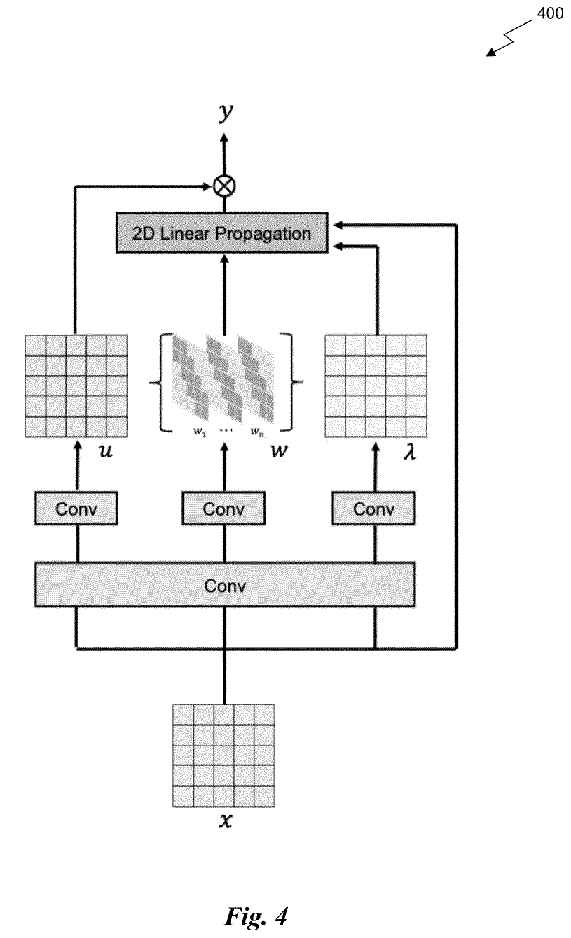

FIGS. 4-6 illustrate various architectural embodiments associated with GSPN. In these embodiments, GSPN is represented as a generic sequence propagation module that can be seamlessly integrated into neural networks for various visual tasks.

### GSPN Module Macro Design

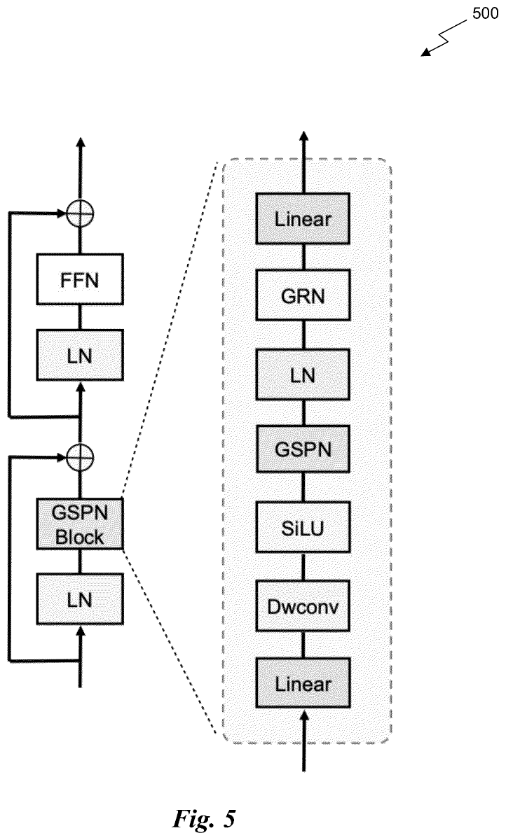

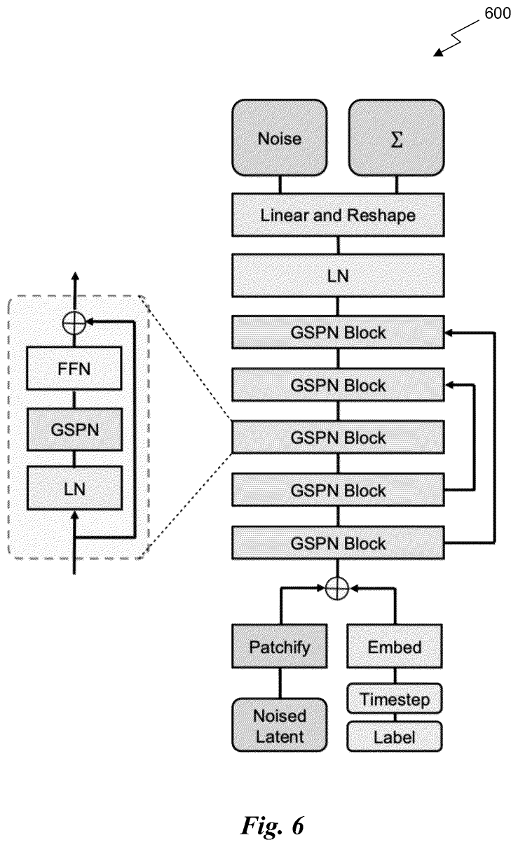

As illustrated in FIGS. 5-6, the top-level designs for both image classification (FIG. 5) and generation (FIG. 6) tasks share fundamental architectural principles. As shown, both architectures integrate commonly used blocks including separable convolutions, layer normalization (LN), Gated Regression Network (GRN), feed-forward networks (FFN), and non-linear activations.

Local vs. Global GSPN

The GSPN operates across entire sequences to capture long-range dependencies, which is referred to as global GSPN. To enhance efficiency, local GSPN is used, which reduces the propagation sequence length by restricting it to localized regions. Local GSPN divides one spatial dimension into g non-overlapping groups, where each group G_{K}={i:iₖ≤i<iₖ₊₁} contains a subset of indices satisfying

$${⋃}_{k = 1}^{g} {G}_{K} = [ 1 , n - 1 ]$$

and Gⱼ∩Gₖ=ø for j≠k. Within each group, local GSPN computes hidden states according to Equation 1:

$${h}_{i}^{c} = {w}_{i}^{c} {h}_{i - 1}^{c} + {λ}_{i}^{c} ⊙ {x}_{i}^{c}$$

for i∈G_{K}, c∈[0, C−1]. This grouping strategy enables parallel computation, reducing complexity by a factor of g compared to global GSPN, achieving O(1) complexity in the extreme case where g=n. In an embodiment, a default group size, for example of g=2, may be adopted for local GSPN. For image classification tasks that prioritize semantic understanding, more global GSPN modules may be employed to capture long-range dependencies and holistic features. In contrast, for dense prediction and generation tasks that require fine-grained spatial details and local consistency, local GSPN modules may be predominantly utilized to preserve spatial structure and local coherence.

### GSPN Module 400

As shown in FIG. 4, a shared 1×1 convolution is applied for dimensionality reduction, followed by three separate 1×1 convolutions to generate input-dependent parameters u, w and λ for 2D linear propagation. These projections and 2D linear propagation are encapsulated within a modular GSPN unit, designed to integrate seamlessly across the architectures described with respect to FIGS. 5-6.

### Image Classification Module 500

As shown in FIG. 5, a four-level hierarchical system architecture 500 for image classification is formed by stacking well-designed GSPN blocks as direct substitution of self-attention with GSPN modules yields suboptimal results. Between the adjacent two levels, each down-sampling operation halves the spatial dimensions. Local GSPN blocks are used in levels 1-2 for efficient processing at higher resolutions, while global GSPN blocks are utilized in levels 3-4 for contextual integration at lower resolutions. This system architecture 500 balances computational efficiency with representational capacity, enabling effective local feature extraction at higher resolutions while facilitating global information aggregation at deeper layers through the transition from local to global GSPN blocks.

### Class-Conditional Image Generation Module 600

The system architecture for generation is redesigned from the system architecture 500 of FIG. 5, since direct replacement of self-attention with GSPN modules yields limited improvements. FIG. 6 provides an overview of the GSPN system architecture 600 for class-conditional image generation networks. The model integrates timestep t and conditional information y through vector embedding addition. The architecture 600 features skip connections that concatenate shallow and deep layer representations, followed by linear projections. Compared with a self-attention module, positional embeddings are removed and a FFN is incorporated for channel mixing. The final decoding stage transforms the sequence of hidden states through layer normalization and linear projection, reconstructing the spatial layout to predict both noise and diagonal covariance with dimensions matching the input.

### Text-to-Image Generation Module

Text-to-image tasks require extensive training data, making it impractical to train from scratch. Instead of adopting the aforementioned image generation module shown in FIG. 6, the GSPN module 400 in FIG. 4 is integrated directly into the Stable Diffusion (SD) architecture by replacing all self-attention layers with GSPN modules. To leverage prior knowledge and accelerate training, the u, λ, and x parameters in Equation 4 are initialized using the pre-trained query, key, and value weight matrices from SD, capitalizing on the mathematical relationship between GSPN and linear attention as shown in Equation 5.

### Principle of GSPN Design

The following outlines design principles for GSPN at both macro and micro scales, contrasting them with classic attention and Mamba modules. These principles may serve as guidelines for optimizing GSPN networks across various computer vision tasks.

Combination of global and local GSPN. Local GSPN blocks are applied to the early stages for efficient processing of fine-grained spatial details. The subsequent global GSPN blocks aggregate long-range contextual information for higher-level semantic understanding. This hierarchical design achieves an optimal trade-off between accuracy and efficiency, and improves both tasks by accuracy and Fréchet Inception Distance (FID).

Learnable merging better than manual design. In previous work, spatial propagation network (SPN) applies manual merging via max pooling operations to combine multi-directional scan information, while GSPN implements a linear layer to dynamically aggregate features from different scanning directions. This data-driven merging strategy enables the network to adaptively weight and combine directional information based on the current input propagation.

No Positional Embedding. The GSPN design demonstrates that explicit positional embeddings are unnecessary for both classification and generation tasks, as spatial information is inherently encoded through the scanning process. This design choice effectively addresses any aliasing issues, while departing from conventional approaches in DiT-based methods that rely on learnable Adaptive Prior rEfinement (APE) with sinusoidal functions. GSPN can remove Positional Encoding (PE) for both tasks without negative effects.

Fewer normalization layers. By minimizing normalization layers, improved computational efficiency and reduced model complexity are achieved without sacrificing performance. This suggests that the traditional extensive use of normalization layers may be redundant in GSPN as the w is normalized through the stability-context condition.

GLU is not effective in GSPN. Unlike Mamba, Gated Linear Units (GLU) do not provide significant benefits to GSPN, and accordingly multi-dimensional linear propagation may already provide gating mechanisms.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

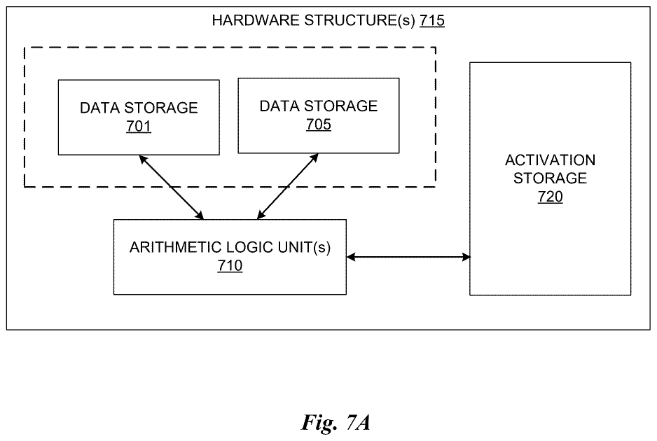

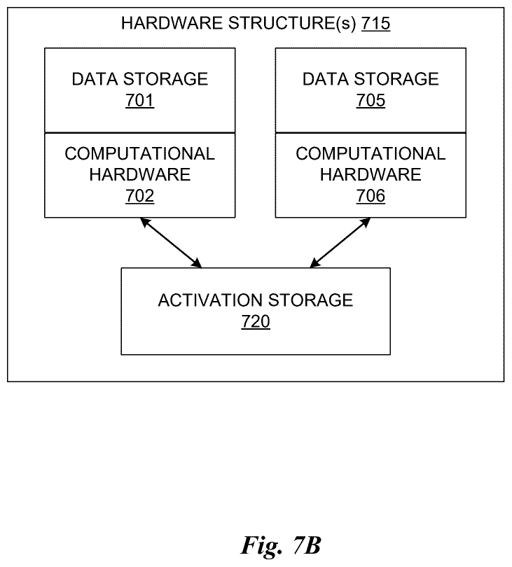

As noted above, a deep learning or neural learning system needs to be trained to generate inferences from input data. Details regarding inference and/or training logic 715 for a deep learning or neural learning system are provided below in conjunction with FIGS. 7A and/or 7B.

In at least one embodiment, inference and/or training logic 715 may include, without limitation, a data storage 701 to store forward and/or output weight and/or input/output data corresponding to neurons or layers of a neural network trained and/or used for inferencing in aspects of one or more embodiments. In at least one embodiment data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 701 may be included with other on-chip or off-chip data storage, including a processor's L1, L2, or L3 cache or system memory.

In at least one embodiment, any portion of data storage 701 may be internal or external to one or more processors or other hardware logic devices or circuits. In at least one embodiment, data storage 701 may be cache memory, dynamic randomly addressable memory (“DRAM”), static randomly addressable memory (“SRAM”), non-volatile memory (e.g., Flash memory), or other storage. In at least one embodiment, choice of whether data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a data storage 705 to store backward and/or output weight and/or input/output data corresponding to neurons or layers of a neural network trained and/or used for inferencing in aspects of one or more embodiments. In at least one embodiment, data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 705 may be included with other on-chip or off-chip data storage, including a processor's L1, L2, or L3 cache or system memory. In at least one embodiment, any portion of data storage 705 may be internal or external to on one or more processors or other hardware logic devices or circuits. In at least one embodiment, data storage 705 may be cache memory, DRAM, SRAM, non-volatile memory (e.g., Flash memory), or other storage. In at least one embodiment, choice of whether data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 701 and data storage 705 may be separate storage structures. In at least one embodiment, data storage 701 and data storage 705 may be same storage structure. In at least one embodiment, data storage 701 and data storage 705 may be partially same storage structure and partially separate storage structures. In at least one embodiment, any portion of data storage 701 and data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710 to perform logical and/or mathematical operations based, at least in part on, or indicated by, training and/or inference code, result of which may result in activations (e.g., output values from layers or neurons within a neural network) stored in an activation storage 720 that are functions of input/output and/or weight parameter data stored in data storage 701 and/or data storage 705. In at least one embodiment, activations stored in activation storage 720 are generated according to linear algebraic and or matrix-based mathematics performed by ALU(s) 710 in response to performing instructions or other code, wherein weight values stored in data storage 705 and/or data 701 are used as operands along with other values, such as bias values, gradient information, momentum values, or other parameters or hyperparameters, any or all of which may be stored in data storage 705 or data storage 701 or another storage on or off-chip. In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 701, data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, data storage 701 and data storage 705, which may be used to store weight values and/or other information, including bias values, gradient information, momentum values, and/or other parameter or hyperparameter information. In at least one embodiment illustrated in FIG. 7B, each of data storage 701 and data storage 705 is associated with a dedicated computational resource, such as computational hardware 702 and computational hardware 706, respectively. In at least one embodiment, each of computational hardware 706 comprises one or more ALUs that perform mathematical functions, such as linear algebraic functions, only on information stored in data storage 701 and data storage 705, respectively, result of which is stored in activation storage 720.

In at least one embodiment, each of data storage 701 and 705 and corresponding computational hardware 702 and 706, respectively, correspond to different layers of a neural network, such that resulting activation from one “storage/computational pair 701/702” of data storage 701 and computational hardware 702 is provided as an input to next “storage/computational pair 705/706” of data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Neural Network Training and Deployment

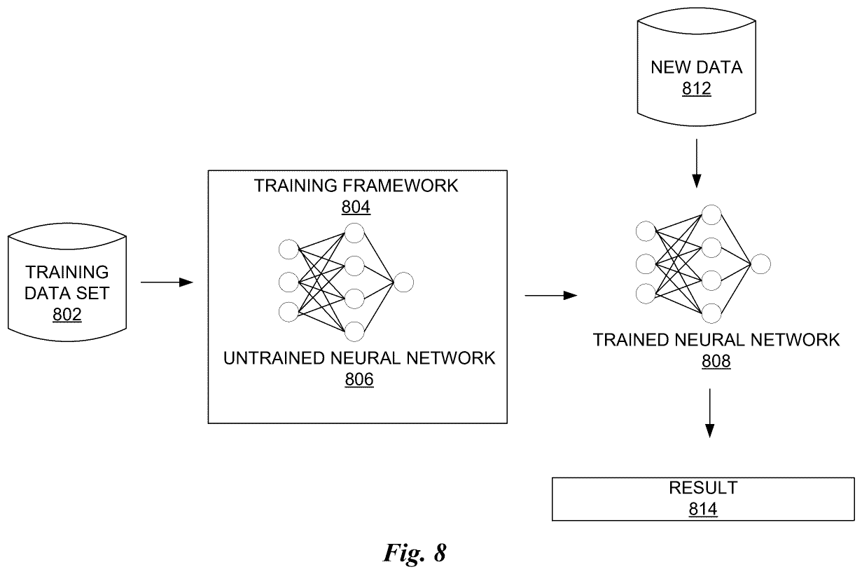

FIG. 8 illustrates another embodiment for training and deployment of a deep neural network. In at least one embodiment, untrained neural network 806 is trained using a training dataset 802. In at least one embodiment, training framework 804 is a PyTorch framework, whereas in other embodiments, training framework 804 is a Tensorflow, Boost, Caffe, Microsoft Cognitive Toolkit/CNTK, MXNet, Chainer, Keras, Deeplearning4j, or other training framework. In at least one embodiment training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having known output and the output of the neural network is manually graded. In at least one embodiment, untrained neural network 806 is trained in a supervised manner processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on known input data, such as new data 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map, which is a type of trained neural network 808 capable of performing operations useful in reducing dimensionality of new data 812. In at least one embodiment, unsupervised training can also be used to perform anomaly detection, which allows identification of data points in a new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new data 812 without forgetting knowledge instilled within network during initial training.

### Data Center

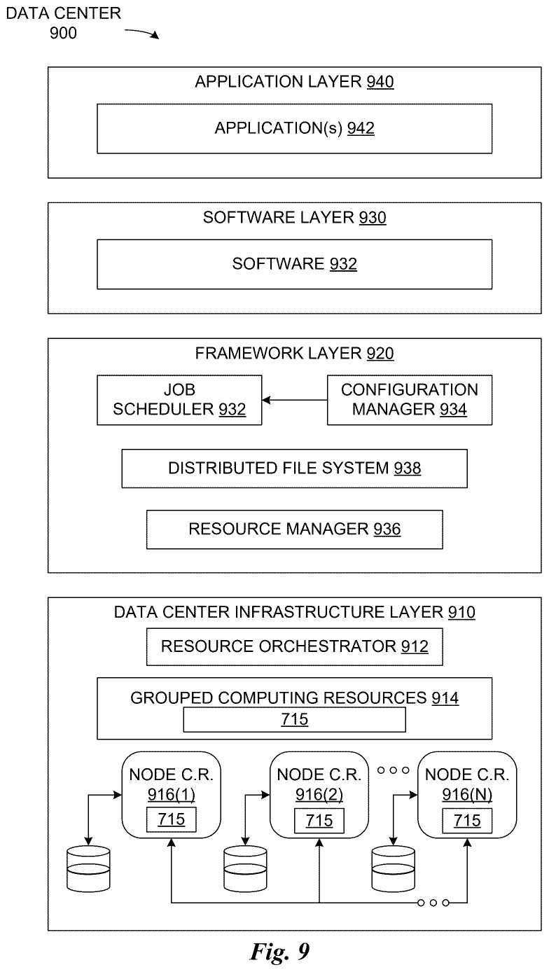

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 922 may configure or otherwise control one or more node C.R.s 916(1)-916(N) and/or grouped computing resources 914. In at least one embodiment, resource orchestrator 922 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 932, a configuration manager 934, a resource manager 936 and a distributed file system 938. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920 including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

As described herein, a method, computer readable medium, and system are disclosed to provide attention information for multi-dimensional data. In accordance with FIGS. 1-6, embodiments may provide models usable for performing inferencing operations and for providing inferenced data. The models may be stored (partially or wholly) in one or both of data storage 701 and 705 in inference and/or training logic 715 as depicted in FIGS. 7A and 7B. Training and deployment of the models may be performed as depicted in FIG. 8 and described herein. Distribution of the models may be performed using one or more servers in a data center 900 as depicted in FIG. 9 and described herein.

What is claimed is:

1. A method, comprising:
computing attention information for at least a portion of a multi-dimensional datum using multi-dimensional linear propagation; and
performing a computer vision task using the attention information to generate an output for the at least a portion of a multi-dimensional datum.

2. The method of claim 1, wherein the multi-dimensional datum is an image.

3. The method of claim 1, wherein the multi-dimensional linear propagation is performed per feature channel of a plurality of feature channels.

4. The method of claim 1, wherein the multi-dimensional linear propagation is performed per 2D line of the multi-dimensional datum.

5. The method of claim 4, wherein 2D line is a row of the multi-dimensional datum.

6. The method of claim 4, wherein the 2D line is a column of the multi-dimensional datum.

7. The method of claim 1, wherein the multi-dimensional linear propagation is a linear recurrent process that includes, for each line in the at least a portion of a multi-dimensional datum, computing each item in a hidden state by:
computing a weighted sum of neighboring values from hidden states of a prior line to form a first result,
computing an element-wise product of the line with a scaling parameter to form a second result, and
computing a sum of the first result and the second result.

8. The method of claim 7, wherein the neighboring values are values of three elements in the prior line that are directly adjacent to the item in the hidden state.

9. The method of claim 1, wherein the multi-dimensional datum is an image, the computer vision task is image classification and the output corresponds to a predicted class label for the image.

10. The method of claim 1, wherein the attention information is computed via a network module that is incorporated into a foundation model configured for the computer vision task.

11. A method, comprising:
at a device:
computing attention information for at least a portion of a multi-dimensional datum using multi-dimensional linear propagation; and
providing the attention information to a downstream task to be performed for the at least a portion of a multi-dimensional datum.

12. The method of claim 11, wherein the multi-dimensional datum is a two-dimensional (2D) datum.

13. The method of claim 11, wherein the multi-dimensional datum is a three-dimensional (3D) datum.

14. The method of claim 11, wherein the multi-dimensional datum is an image.

15. The method of claim 11, wherein computing the attention information includes capturing a local context for each of a plurality of regions of the multi-dimensional datum.

16. The method of claim 11, wherein computing the attention information includes capturing a global context across an entirety of the multi-dimensional datum.

17. The method of claim 11, wherein the multi-dimensional linear propagation is performed per feature channel of a plurality of feature channels.

18. The method of claim 11, wherein the multi-dimensional linear propagation is performed per row of the multi-dimensional datum.

19. The method of claim 11, wherein the multi-dimensional linear propagation is performed per column of the multi-dimensional datum.

20. The method of claim 11, wherein the multi-dimensional linear propagation is a linear recurrent process that includes, for each line in the at least a portion of a multi-dimensional datum, computing each item in a hidden state by:
computing a weighted sum of neighboring values from hidden states of a prior line to form a first result,
computing an element-wise product of the line with a scaling parameter to form a second result, and
computing a sum of the first result and the second result.

21. The method of claim 20, wherein the neighboring values are values of three elements in the prior line that are directly adjacent to the item in the hidden state.

22. The method of claim 20, wherein weights used to compute the weighted sum are stored in a normalized tridiagonal matrix.

23. The method of claim 22, wherein the weights are learnable and input-dependent.

24. The method of claim 22, wherein the normalized tridiagonal matrix is row stochastic.

25. The method of claim 20, wherein the scaling parameter is learnable and input-dependent.

26. The method of claim 11, wherein the attention information is output via a single output layer of a neural network used to compute the attention information.

27. The method of claim 11, wherein the attention information is computed without use of positional embeddings.

28. The method of claim 11, wherein the downstream task is a computer vision task.

29. The method of claim 28, wherein the computer vision task is image classification.

30. The method of claim 28, wherein the computer vision task is class-conditional image generation.

31. The method of claim 28, wherein the computer vision task is text-to-image generation.

32. The method of claim 11, wherein the attention information is computed via a network module that is incorporated into a foundation model configured for the downstream task.

33. A system, comprising:
a non-transitory memory comprising instructions; and
one or more processors in communication with the non-transitory memory, wherein the one or more processors execute the instructions to:
compute attention information for at least a portion of a multi-dimensional datum using multi-dimensional linear propagation; and
provide the attention information to a downstream task to be performed for the at least a portion of a multi-dimensional datum.

34. The system of claim 33, wherein the multi-dimensional linear propagation is a linear recurrent process that includes, for each line in the at least a portion of a multi-dimensional datum, computing each item in a hidden state by:
computing a weighted sum of neighboring values from hidden states of a prior line to form a first result,
computing an element-wise product of the line with a scaling parameter to form a second result, and
computing a sum of the first result and the second result.

35. A non-transitory computer-readable media storing computer instructions which when executed by one or more processors of a device cause the device to:
compute attention information for at least a portion of a multi-dimensional datum using multi-dimensional linear propagation; and
provide the attention information to a downstream task to be performed for the at least a portion of a multi-dimensional datum.

36. The non-transitory computer-readable media of claim 35, wherein the multi-dimensional linear propagation is a linear recurrent process that includes, for each line in the at least a portion of a multi-dimensional datum, computing each item in a hidden state by:
computing a weighted sum of neighboring values from hidden states of a prior line to form a first result,
computing an element-wise product of the line with a scaling parameter to form a second result, and
computing a sum of the first result and the second result.
